(19) United States
(12) Patent Application Publication
(10) Pub. No.: US 2005/0171844 A1
(43) Pub. Date: Aug. 4, 2005

(54) Apparatus and methods for streamlined term adjustment

(76) Inventors: John B. Ferber, Baltimore, MD (US); Eric Kronthal, Baltimore, MD (US)

Correspondence Address: Finnegan, Henderson, Farabow,;Garrett & Dunner, L.L.P., 1300 I Street, N.W., Washington, DC, 20005-3315, US

(21) Appl. No.: 11/034,919

(22) Filed: Jan. 14, 2005

Related U.S. Application Data
(63) Continuation of application No. 60/536,501, filed on Jan. 15, 2004.

(51) Int. Cl. G06F 17/60

(52) U.S. Cl. 705/14

(57) ABSTRACT

Embodiments consistent with the present invention enable an advertising client to vary terms of an advertising campaign automatically in order to react to changing business conditions. An advertising client and a publisher establish terms of an advertising campaign including a unit cost for placement of advertisements and a range of acceptable changes. The unit cost may use any pricing model, such as cost per mille, cost per click, or cost per action. During the advertising campaign, the advertising client may submit a change that is automatically implemented to alter the advertising campaign.

### RELATED APPLICATION

This application claims the benefit of priority of U.S. Provisional Patent Application No. 60/536,501, filed Jan. 15, 2004, entitled Apparatus and Methods for Streamlined Term Adjustment, incorporated herein by reference.

### BACKGROUND OF THE INVENTION

1. Field of the Invention

Principles consistent with embodiments of the present invention relate generally to facilitating the interaction of parties engaged in electronic market transactions and, more specifically, to facilitating the streamlined adjustment of contractual relationships involving advertising clients and publishers.

2. Description of Related Art

With the increased use of technology in the home and in business, consumers are spending more and more time using the Internet. To reach these consumers, advertisers would like to make effective use of advertisements on Internet websites. Accordingly, it is desirable to plan the placement of ads in order to maximize the revenue generated by the ads. One consideration for advertising clients (e.g., advertisers) trying to maximize ad revenue is the unit cost paid to advertising publishers (e.g., websites) in order to have ads placed. The unit cost is a dynamic quantity and can be expressed in a variety of different ways.

One cost model expresses unit cost in Cost Per Mille (CPM). The CPM cost is the amount charged per one thousand impressions of an ad. With the CPM model, the advertising client is charged based on the number of times an ad is viewed by a consumer. Another model for expressing unit cost is Cost Per Click (CPC). The CPC model refers to the unit cost charged to an advertising client when a consumer not only views an ad, but also expresses interest in the ad by “clicking” on it to obtain more information. For example, a consumer may click on an ad by pointing at the ad using a mouse or touchpad and selecting the ad by pressing a button on the mouse or tapping the touchpad. Using the CPC model, an advertiser pays only for ads that elicit some response from a consumer.

Yet another model for expressing unit cost is the Cost Per Action (CPA) model. In the CPA model, a unit cost is charged to the advertising client when a consumer performs a qualifying action related to an ad. The action may be specified by an advertising client and may include, for example, obtaining information about the consumer, such as his e-mail address, or having the consumer purchase products and/or services offered by the advertising client. In the CPA model, advertisers pay only for ads that result in a desired action being taken by a consumer. In addition to the CPM, CPC, and CPA cost models, any other method of expressing unit cost may be used consistent with the present invention.

The unit cost is an important quantity for an advertising client. Not only does unit cost affect the total cost of the advertising campaign, but it may also play a role in determining the time and the location of an ad's placement. Furthermore, unit cost may influence the frequency of the ad's presentation (i.e., the ad's volume). Given the dynamic nature of online business transactions, it is important for an advertising client to be able to control an advertising campaign quickly and efficiently. Existing processes for controlling an advertising campaign can be cumbersome and time intensive, involving a significant amount of manual labor.

For example, an advertiser using a conventional advertising placement system may create an ad campaign by specifying aspects of the campaign such as a unit cost model to be used, a price per unit, a length of time for the campaign, etc. The aspects specified by the advertiser must be approved manually by an advertising publisher or other conventional advertising placement system. This manual review can add significant time to the beginning of a new advertising campaign and the uncertainty of the approval process may make it difficult for the advertiser to plan its advertising strategy. If the advertiser later wishes to change an aspect of the campaign, additional manual processing is necessary, causing additional delays and uncertainty.

For example, in traditional systems, an adverting client may submit a price change request by phone or e-mail to a Delivery Manager (DM) for approval. If the price change is approved, the DM manually requests a finance department to ensure that the advertising client will meet its financial obligations, such as previously determined credit requirements, using the proposed new price. Once the finance department processing is complete, a campaign manager may be directed to execute a lengthy manual process to recreate the ad campaign by revising the balance of the ads to be delivered, implement a new unit price based upon the changed price, and update the appropriate computer servers to change the presentation of the ad to implement the new ad campaign. In such a conventional system, a number of factors contribute to significant delays. For example, if the DM is slow in reading its e-mail, the entire process may be stalled. Furthermore, many parts of the process require manual execution, adding time and effort to the process.

Accordingly, there is a need for systems and methods that allow advertising clients to place and modify advertising campaigns dynamically in a streamlined manner. Furthermore, there is a need for systems and methods to allow an advertising client to change the unit cost of an advertising campaign in real time.

### SUMMARY OF THE DISCLOSURE

A method consistent with the present invention modifies an electronic advertising campaign by determining terms of the advertising campaign, including a unit price, receiving a proposed change to the unit price, and automatically implementing the proposed change in real time to alter placement of an electronic advertisement related to the advertising campaign.

In one embodiment of the present invention, a system for adjusting a term of an agreement for an electronic advertising campaign, comprises a database that stores terms of the advertising campaign, including a range of acceptable changes, and a change processor that receives a proposed change to a term of the advertising campaign, automatically determines whether the proposed change is within the range of acceptable changes, and when it is determined that the proposed change is within the range of acceptable changes, implements the proposed change by directing advertisement placement based on the proposed change.

Another method of modifying an online advertising campaign consistent with the present invention determines terms of the advertising campaign, including a unit price and a range of acceptable changes, receives a proposed change to the unit price, and automatically determines whether the proposed change falls within the range of acceptable change. When the proposed change falls within the range of acceptable changes, a number of units remaining in the advertising campaign is automatically calculating based on the proposed change, and placement of an online advertisement related to the advertising campaign is directed in real time using the number of units remaining and the proposed change.

### BRIEF DESCRIPTION OF THE DRAWINGS

The accompanying drawings, which are incorporated in and constitute a part of this specification, illustrate embodiments of the invention and, together with the description, explain aspects of the invention. In the drawings:

FIG. 1 depicts an exemplary system environment for implementing features consistent with principles of an embodiment of the present invention;

FIG. 2 depicts an exemplary block diagram of an advertising client device consistent with principles of an embodiment of the present invention;

FIG. 3 depicts an exemplary block diagram of a server consistent with principles of an embodiment of the present invention;

FIGS. 4A-4C show exemplary screen shots for a user interface consistent with principles of an embodiment of the present invention;

FIG. 5 depicts a process to create an advertising campaign consistent with principles of an embodiment of the present invention; and

FIG. 6 depicts a process to change an established advertising campaign in real time, consistent with principles of an embodiment of the present invention.

### DETAILED DESCRIPTION

Reference will now be made in detail to the features of embodiments of the present invention, examples of which are illustrated in the accompanying drawings. Wherever possible, the same reference numbers will be used throughout the drawings to refer to the same or like parts.

1. Introduction

Embodiments consistent with the present invention enable an advertising client to vary terms of an advertising campaign in real time in order to react to changing business conditions. For example, an advertising client (e.g., an advertiser) may establish terms of an advertising campaign including a unit cost for placement of advertisements and a range of acceptable changes. The unit cost may use any pricing model, such as cost per mille, cost per click, or cost per action. During the advertising campaign, the advertising client may submit a change to the established terms (e.g., a change in the unit cost, the pricing model, etc.). If the change is accepted (e.g., if the change is within the range of acceptable changes), it is automatically implemented to alter the advertising campaign in real time. This automatic implementation may change the placement of advertisements based on the changed term.

Various known methods may be used to determine advertisement placement, e.g., the time and place to show advertising content. For example, ad placement may be determined in an attempt to maximize economic yield for the advertising client and/or the publisher. In one embodiment, an advertising client may receive a large amount of business based upon ads that have been placed in conjunction with an advertising campaign. Accordingly, the advertising client may wish to reduce the number of ads that are placed in the near term future to save on advertising costs. Alternatively, an advertising client experiencing slow business may wish to generate additional business by placing additional ads. In addition to the quantity of ads placed, the advertising client may want to vary other aspects of a campaign such as the target audience, the location of the placement, timing of ad placement, etc.

Because the environment for online business is very dynamic, it is desirable to facilitate such changes in an efficient, streamlined manner. Certain embodiments of the invention enable an advertising client to vary terms of a contract with a publisher in an automated manner in order to react to changing business conditions in real time. More specifically, embodiments of the invention permit an advertising client to adjust a unit cost that it will pay for the placement of an ad, thus impacting the terms, such as the volume, of an ad campaign. These changes may be executed in real-time so that the effects may be realized almost immediately. Alternatively, the changes may be processed at a set interval, such as once per hour or once per day.

2. Exemplary System Architecture

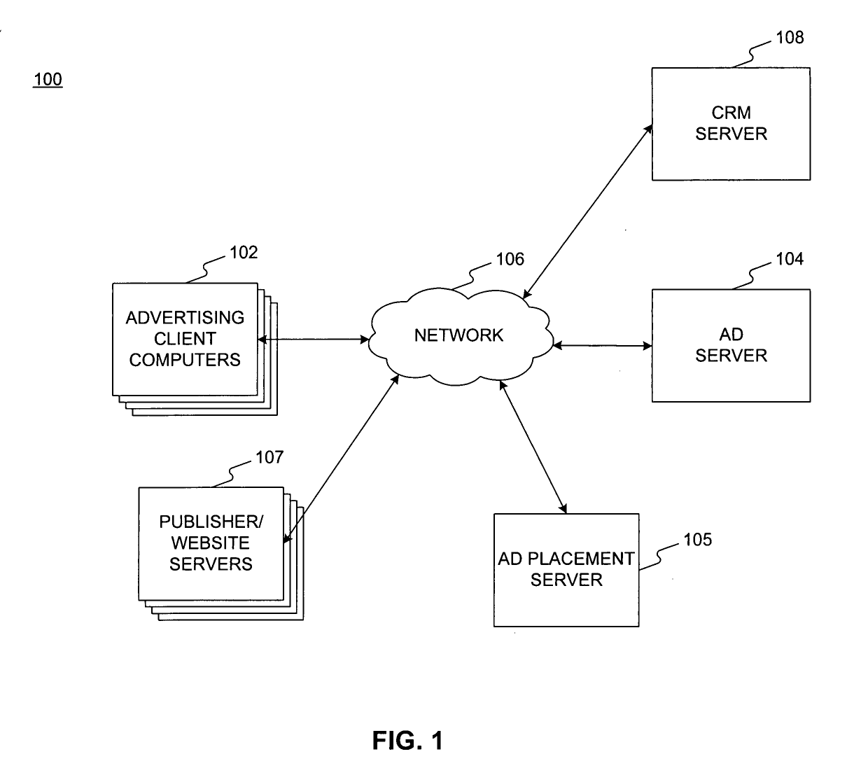

FIG. 1 depicts an exemplary AdBid system 100, such as AdBid system, consistent with an embodiment of the present invention. The components of system 100 can be implemented through any suitable combinations of hardware, software and/or firmware. As shown in FIG. 1, system 100 may include one or more Advertising Client Computers 102, an Ad Server 104, an Ad Placement Server 105, one or more Publisher/Website Servers 107, and a Customer Relationship Management (CRM) Server 108, each communicably coupled over a network 106. Network 106 may be any network and/or combination of networks, including, for example, the Internet.

Advertising Client Computers 102 may receive control input from users (e.g., advertising clients) through a graphical user interface to control an advertising campaign. The control input may include, for example, an advertising cost model, a price per unit, etc. The price per unit may be based on whether the advertising client has a contract for CPM, CPC, or CPA unit costs. Advertising Client Computers 102 may send the control input to Ad Server 104 over network 106. Ad Server 104 may be a central server for AdBid system 100 and may control the timing and placement of advertisements, act as a data server for the advertisements themselves, and track historical data (e.g., number of units delivered, number of views and click throughs, etc.) for advertising campaigns.

Ad Server 104 may pass the control input, including the price per unit, to CRM Server 108 over network 106. CRM Server 108 may store and manage a wide range of information relating to each advertising client. Such information may include, for example, contact information, billing information, and information regarding business relationships and contract terms. This information may also include budgetary data associated with an ad campaign. Using input received from Ad Server 104 (including, e.g., the price per unit information), CRM Server 108 may calculate the price change resulting from the price per unit information and the resulting effect on stored contractual terms, which may include computing the number of outstanding units remaining.

Further referring to FIG. 1, Ad Placement Server 105 may determine ad placement information using, e.g., the results of calculations performed by CRM Server 108, control input from advertising clients, etc. Ad placement information may include, for example, a time at which the ad is displayed, a website on which it is displayed, or the type of ad displayed (e.g., pop-up or banner). Data produced by CRM Server 108 may be periodically updated (for example, once every hour or once every minute) and sent to Ad Placement Server 105 in order to keep the calculation results as accurate as possible. Using information from CRM Server 108 and Ad Server 104, Ad Placement Server 105 may use predictive algorithms to determine an optimum time and/or place for displaying an advertisement. Such optimum placement information may be passed back to Ad Server 104 over network 106. Using the optimum placement information received from Ad Placement Server 105, Ad Server 104 may direct Publisher Servers 107 to present appropriate ads to consumer computers attached (not shown) to the network. Consistent with embodiments of the present invention, Ad Server 104, Ad Placement Server 105, CRM Server 108, and Publisher Servers 107 may be separate, as shown, or one or more of the components may be combined or omitted. Alternatively, one or more of the functions described herein may be performed by other components of AdBid system 100. For example, Ad Server 104 may determine optimum advertising placement or Ad Placement Server 105 may send placement instructions directly to Publisher Servers 107.

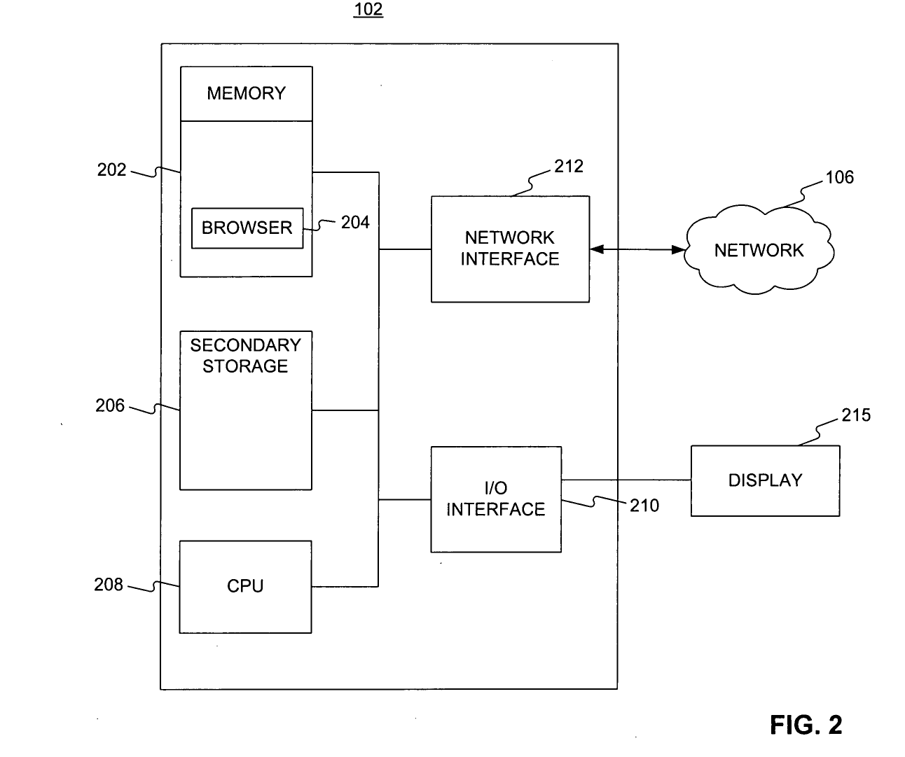

FIG. 2 depicts an exemplary block diagram of one of Advertising Client Computers 102 consistent with an embodiment of the present invention. Advertising Client Computer 102 may be any type of computing device, such as a personal computer or workstation, and may, for example, comprise a memory 202, a secondary storage 206, a central processing unit (CPU) 208, an input/output (I/O) interface 210, a network interface 212, and a display 215. Computer software may execute on CPU 208 and may reside, in whole or in part, in memory 202 and/or secondary storage 206. For example, such computer software may comprise a browser 204, including conventional browser applications available from Microsoft or Netscape.

In one embodiment, an advertiser may use browser 204 and network interface 212 to access Ad Server 104 via network 106 to place or change an advertising campaign. It may be appreciated by one of ordinary skill in the art that Advertising Client Computer 102 may include additional software applications to facilitate interaction with network 106 and/or Ad Server 104.

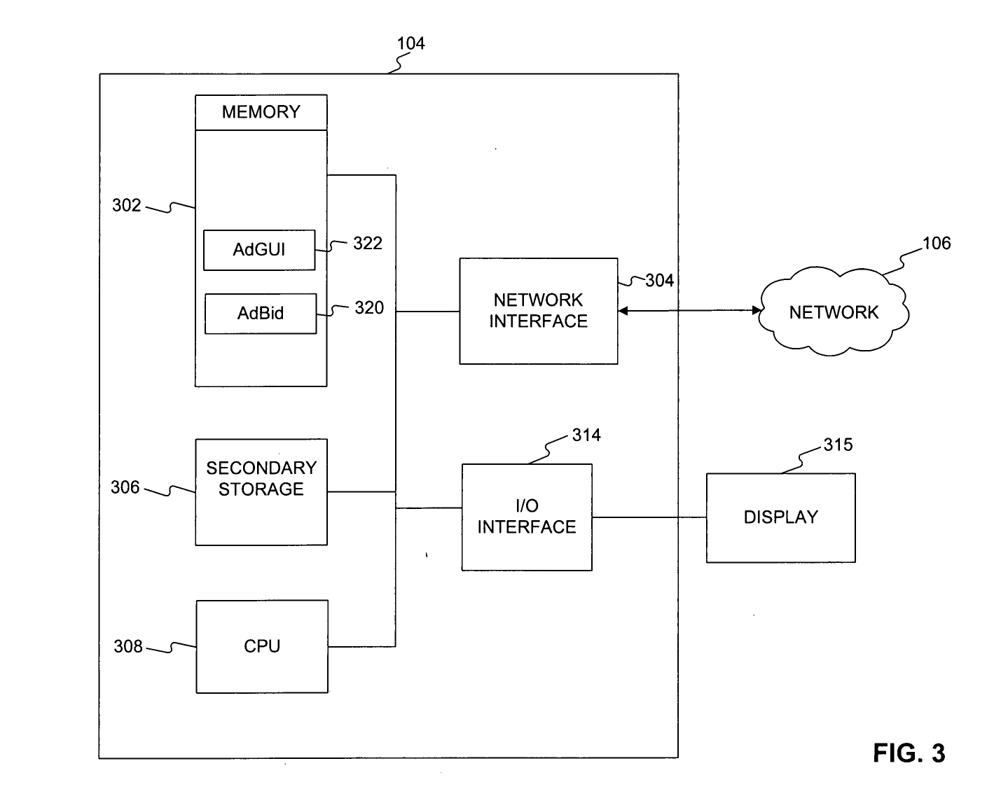

FIG. 3 depicts an exemplary block diagram of Ad Server 104 consistent with an embodiment of the present invention. Ad Server 104 may be implemented as a server computer and may, for example, include a memory 302, a network interface 304, a secondary storage 306, a central processing unit (CPU) 308, and an input/output (I/O) interface 314. Computer software may execute on CPU 308 and may reside, in whole or in part, in memory 302 and/or secondary storage 306. Computer software may include one or more software applications which, in conjunction with network interface 304, facilitate interaction between Ad Server 104, Advertising Client Computers 102, Ad Placement Server 105, network 106, and/or CRM Server 108.

AdGUI 322 may be computer software that provides a Graphical User Interface (GUI) to provide user access to Ad Server 104, and may be stored in memory 332. For example, AdGUI 322 may utilize a standard web browser interface to enable an administrator to make changes to an advertising campaign. AdBid 320 may be computer software, that may be stored in memory 302 to enable advertising clients, e.g., advertisers at Advertising Client Computers 102, to interface with Ad Server 104. For example, an advertising client may use AdBid 320 to provide control input such as a name and password to sign into AdBid system 100, request a price history of the advertising client's ad campaigns, implement a unit price change to an existing ad campaign, pause an ongoing ad campaign, etc.

While computer software applications used to facilitate interaction between the advertising client computers 102 and Ad Server 104 are described as residing on Ad Server 104, it may be appreciated by one of ordinary skill in the art that the computer software may reside on or be distributed among other components such as those shown in FIG. 1. Additionally, it may be appreciated by one of ordinary skill in the art that Ad Server 104 may include fewer or more components than shown, such as a database that stores advertisements and other information related to advertising campaigns of the advertising clients.

3. Sample Screen Shots

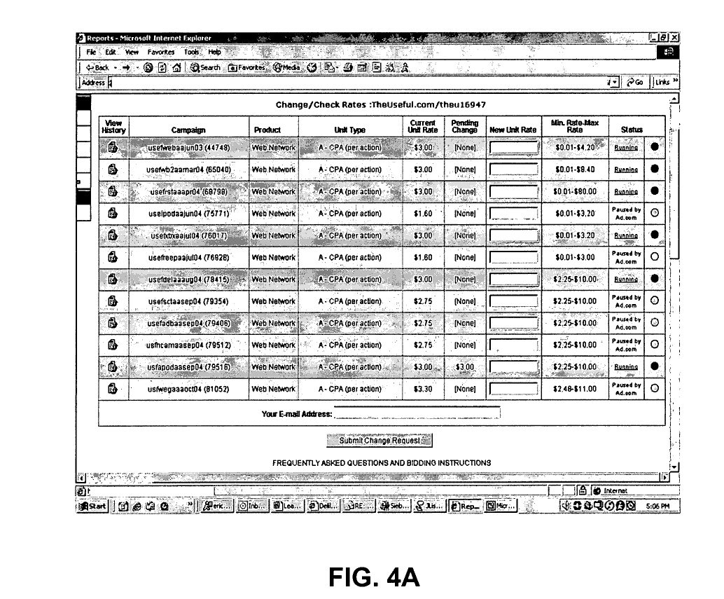

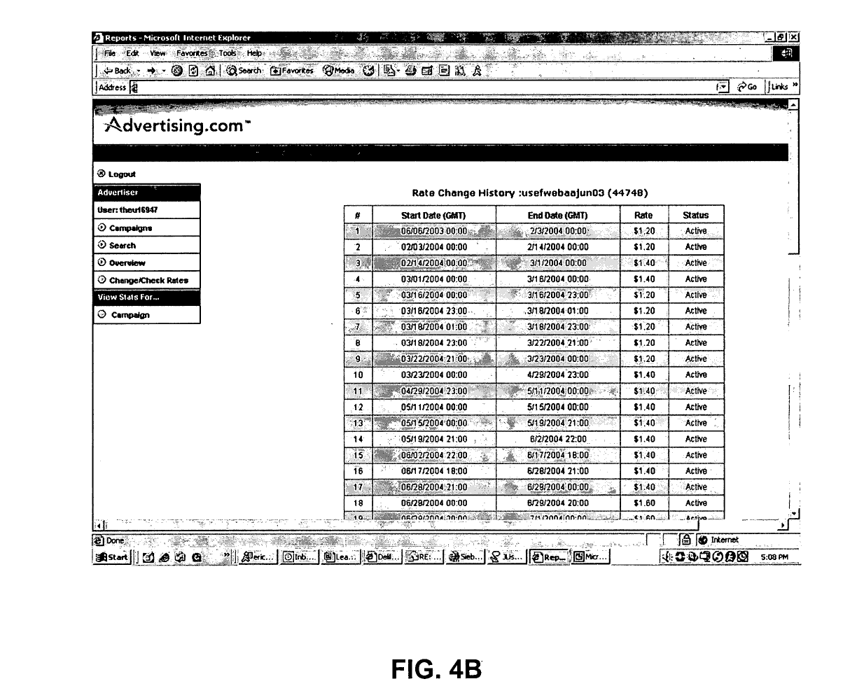

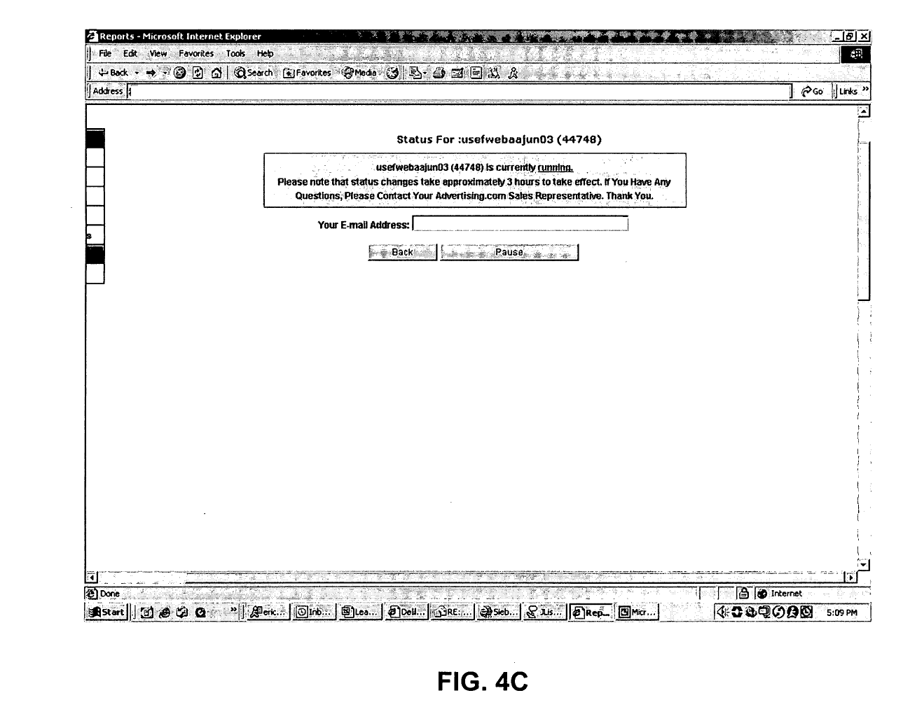

FIGS. 4A-4C depict exemplary screen shots of GUIs that may be produced by AdBid 320 consistent with an embodiment of the present invention. FIG. 4A is a screen shot of an exemplary change/check rates screen that enables an advertising client to check the current per unit price of a campaign or to modify the campaign. The change/check rates screen may display, for example, a campaign name, product, unit type (e.g., CPA, CPC, etc.), current unit price, pending change, new unit price, minimum rate, maximum rate, and status. The change/check rates screen may also provide access to a campaign history using, e.g., hyperlinks, or provide a button for the advertising client to pause or restart a campaign. The minimum and maximum rates may be determined, for example, when an advertising campaign is established and the advertising client may input a new unit rate within the minimum and maximum rates to request a change in the unit price. For example, the client may wish to raise the unit price in order to place more ads or to have ads placed on more desirable websites. In another example, the client may wish to pause a campaign to allow time to catch up with a surplus of orders.

FIG. 4B is a screen shot of an exemplary rate change history screen for providing an advertising client with data about previous changes to an advertising campaign. This screen may show, for example, a start date, end date, rate, and status for each change, such as a rate change, made during a campaign. Other data may also be displayed, such as a number of impressions (i.e., views), number of clicks, click-through-rate (CTR), number of conversions (e.g., actions), conversion rate, impressions per conversion, etc.

FIG. 4C is a screen shot of an exemplary change status feedback screen for notifying a user that a status change to an advertising campaign has been requested. The change status feedback screen may include, for example, a current status, an e-mail address of the client, and an estimate of when the requested status change will take effect. A similar screen could be used to summarize other requested changes, e.g., a requested unit price change.

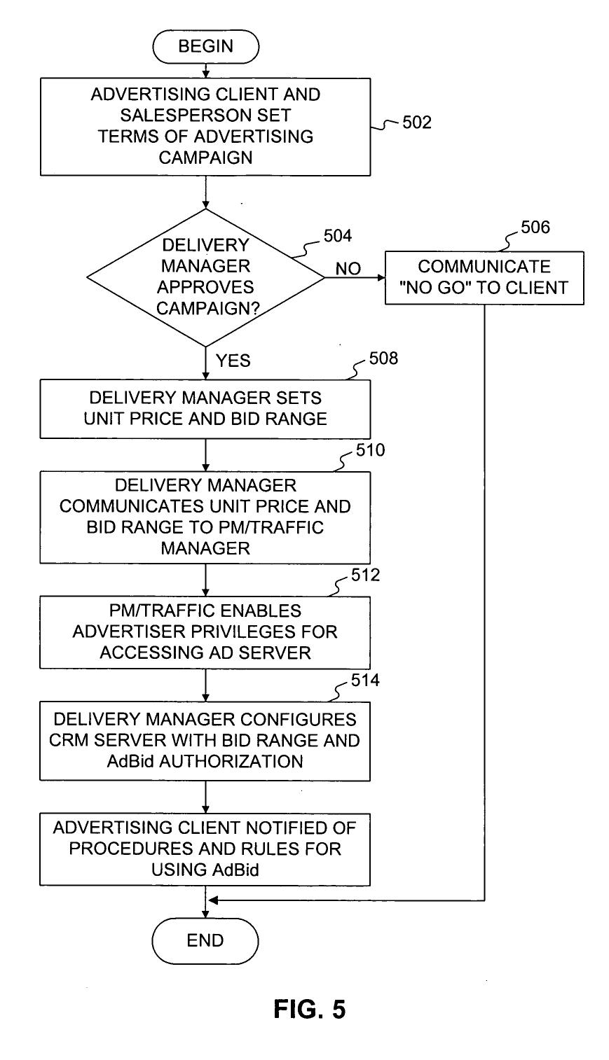

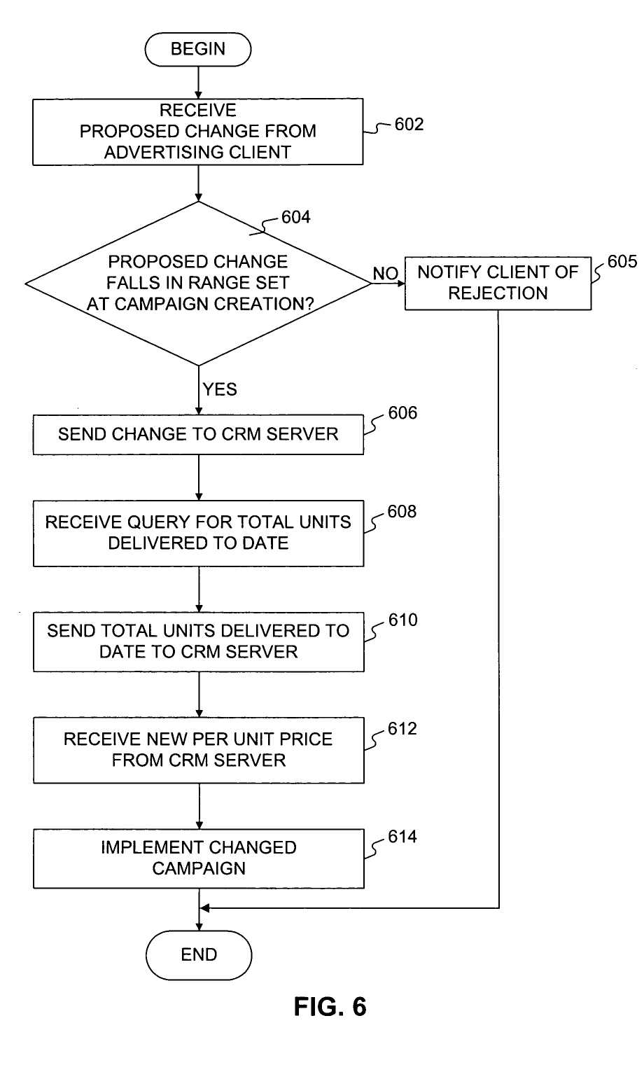

FIGS. 5 and 6 are flowcharts of methods consistent with embodiments of the present invention. FIG. 5 depicts a process to create an advertising campaign and FIG. 6 depicts a process to change an established advertising campaign in real time.

4. Advertising Campaign Creation Process

Referring to FIG. 5, an advertising client may set terms of an advertising campaign (step 502). For example, a salesperson may offer an advertising client advertising services and the salesperson and the advertising client may agree to contractual terms of an ad campaign, which may include, for example: cost model, price per unit, creative content, graphic content, marketing message, budget, conversion process, call to action, etc.

Next, a Delivery Manager (DM) associated with Ad Server 104 may determine whether the potential advertising client or campaign is approved (step 504). If the advertising client or campaign is not approved (step 504, NO), the Delivery Manager or salesperson may communicate a “no-go” status to the client (step 506). If the advertising client is approved (step 504, YES), the DM may use a starting unit price that the client will pay to set maximum and minimum price ranges (e.g., percentages or dollar amounts) that will apply to any changes the advertising client may make using AdBid 320 (step 508). The DM may input these values into Ad Server 104 using, for example, AdGUI 322 or otherwise communicate them to the salesperson and/or a Product Manager (PM)/Traffic Controller (step 510). The PM/Traffic Controller may then perform administrative tasks associated with assigning the advertising client the proper privileges for accessing Ad Server 104 (step 512).

The DM may also configure CRM Server 108, for example using AdGUI 322, with the bid ranges and flag the campaign as one which may have its control inputs automatically changed using AdBid 320 (step 514). Finally, the salesperson may inform the advertising client of procedures and rules associated with using AdBid System 100 (step 516). For example, the rules may include a time each day when any changes to existing ad campaigns will be implemented.

5. Automatic Advertising Change Process

FIG. 6 is a flowchart of a process to change an established advertising campaign in real time. Once an advertising campaign has been established, an advertising client may use Advertising Client Computer 102 to access AdBid 320 and submit a proposed change (step 602). The proposed change may be, for example, a unit price change, pricing model change, etc. If the proposed change is to pause a campaign, AdBid 320 may direct Publisher/Website Servers 107 to pause delivery of ads associated with the campaign for a certain period of time (e.g., 4 hours) or indefinitely.

If the proposed change is a unit price change, Ad Server 104 may determine whether the price change falls within the range set at the creation of the campaign (step 604). Depending on the result of the determination, an appropriate notification, such as an e-mail or text message, may be sent to the DM, an Account Manager, or others associated with Ad Server 104, CRM Server 108, etc. For example, these notifications may be stored by CRM Server 108 as an activity in the history of the ad campaign.

If a price change is accepted (step 604, YES), Ad Server 104 may send the new unit price value to CRM server 108 (Step 606). If the price change is not accepted (step 604, NO), the client is notified of the rejection (step 605) and the notification may be recorded in the campaign history. CRM server 108 may store data corresponding to an ad campaign, such as the start and end dates of the campaign, the old unit price, the status, etc. CRM Server 108 may then generate a query for Ad Server 104 to determine the total number of units delivered to date for the ad campaign (step 608). The total number of units delivered may be, for example, the number of impressions or the total number of clicks to date. The total number of units delivered may be returned to CRM Server 108 (step 610). CRM Server 108 may store information related to the change, such as the date of the change, the old unit price, total charge of advertising prior to change, number of units remaining in the campaign, etc. CRM Server 108 may then calculate the new unit price based on, for example, the number of units remaining, and update Ad Server 104 with this information (step 612). Ad Server 104 may then direct that the changed campaign be implemented (step 614). For example, Ad Server 104 may send the requested change, new unit price, etc. to Ad Placement Server 105 to determine the times and locations of ad placement for the changed campaign. Using this placement information, Ad Server 104 may direct Publisher Servers 107 to serve campaign ads accordingly.

In one embodiment, AdBid 320 may process a price change within a certain time period of when the change is submitted, for example, within one minute or one hour. Price changes may be presented to the advertising client based on a variety of cost models, including the CPA cost model. AdBid 320 may additionally inform the advertising client that only a certain number of changes may be processed within a certain time period, i.e., 24 hours. This number may be established, for example, when a campaign is created.

In another embodiment, AdBid 320 may honor a pause request regardless of the state of any bid change processing so that price changes may occur while a campaign is paused. Furthermore, AdBid System 100 may implement a new price to compute revenue starting with the time period designated as the process hour, e.g., 12:00 midnight GMT.

In still another embodiment of the present invention, AdBid 320 may be used to forecast the potential effects of a proposed change to an advertising campaign. For example, an advertising client could submit a proposed change and request a forecast of what effects the change would have. AdBid 320 would analyze data related to the client and, optionally, anonymous data related to other clients, to determine the likely impact of the proposed change on clicks, actions, or other effects of the advertising campaign. AdBid 320 could access data stored, for example, in CRM Server 108 in making this determination. The advertising client could be given the option to implement or to cancel the proposed change based on the forecast. In still another embodiment, advertising clients could bid against one another for prime advertisement placements using AdBid 320 and the processes described above. Advertising clients could submit bids as proposed price changes and the bids would be accepted or not based at least partially on bids by other advertising clients. If a client's bid is not accepted, the client may be given the option of submitting another bid for consideration.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of modifying an electronic advertising campaign, comprising:
determining terms of the advertising campaign, including a unit price;
receiving a proposed change to the unit price; and
automatically implementing the proposed change in real time to alter placement of an electronic advertisement related to the advertising campaign.

2. The method of claim 1, wherein the terms further include a range of acceptable changes, further comprising:
determining whether the proposed change falls within the range of acceptable changes.

3. The method of claim 1, wherein the determining of the terms includes at least one of: determining a campaign start date, determining a campaign end date, determining a maximum number of changes, and determining a price model.

4. The method of claim 1, wherein the determining of the terms includes determining the unit price based on a cost per mille (CPM) price model.

5. The method of claim 1, wherein the determining of the terms includes determining the unit price based on a cost per click (CPC) price model.

6. The method of claim 1, wherein the determining of the terms includes determining the unit price based on a cost per action (CPA) price model.

7. The method of claim 1, wherein the automatically implementing to alter placement includes altering at least one of a time at which the advertisement is displayed, a place at which the advertisement is displayed, and a type of advertisement that is displayed.

8. A method of modifying an online advertising campaign, comprising:
determining terms of the advertising campaign, including a unit price and a range of acceptable changes;
receiving a proposed change to the unit price;
automatically determining whether the proposed change falls within the range of acceptable changes; and
when the proposed change falls within the range of acceptable changes,
automatically calculating a number of units remaining in the advertising campaign based on the proposed change, and
using the number of units remaining and the proposed change to direct placement of an online advertisement related to the advertising campaign.

9. The method of claim 1, wherein determining the terms further includes at least one of: determining a campaign start date, determining a campaign end date, determining a maximum number of changes, and determining a price model.

10. The method of claim 9, wherein receiving a proposed change further includes receiving a proposed change to the price model of the unit price.

11. The method of claim 8, wherein determining the terms further includes determining a unit price is based on a cost per mile (CPM) price model.

12. The method of claim 8, wherein determining the terms further includes determining a unit price is based on a cost per click (CPC) price model.

13. The method of claim 8, wherein determining the terms further includes determining a unit price is based on a cost per action (CPA) price model.

14. The method of claim 8, wherein directing placement of the online advertisement includes at least one of: directing a time at which the advertisement is displayed, directing a place at which the advertisement is displayed, and directing a type of advertisement displayed.

15. A system for adjusting a term of an agreement for an electronic advertising campaign, comprising:
a database that stores terms of the advertising campaign, including a range of acceptable changes; and
a change processor that receives a proposed change to a term of the advertising campaign, automatically determines whether the proposed change is within the range of acceptable changes, and when it is determined that the proposed change is within the range of acceptable changes, implements the proposed change by directing advertisement placement based on the proposed change.

16. The system of claim 15, wherein the proposed change is a change to a unit price for placement of electronic advertisements.

17. The system of claim 15, wherein the change processor updates the database based on the proposed change.

18. The system of claim 15,
wherein the database further stores a number of units remaining in the advertising campaign, and
wherein the change processor further calculates the advertisement placement to be directed using the proposed change and the number of units remaining in the advertising campaign.

19. The system of claim 15, wherein the advertisement placement includes at least one of a time at which an online advertisement is displayed, a website on which the online advertisement is placed, and a type of online advertisement displayed.

20. The system of claim 15, wherein the terms of the advertising campaign include at least one of: a campaign start date, a campaign end date, a maximum number of changes, and a price model.

21. The system of claim 20, wherein the proposed change is a change to the price model.
